(19) United States
(12) Patent Application Publication
(10) Pub. No.: US 2012/0227107 A1
(43) Pub. Date: Sep. 6, 2012

(54) CUSTOMER PREMISES EQUIPMENT AND METHOD FOR AVOIDING ATTACKS

(75) Inventors: CHUN-CHIEH YANG, Tu-Cheng (TW); CHI-WEN CHENG, Tu-Cheng (TW)

(73) Assignee: HON HAI PRECISION INDUSTRY CO., LTD., Tu-Cheng (TW)

(21) Appl. No.: 13/072,763

(22) Filed: Mar. 27, 2011

(30) Foreign Application Priority Data
Mar. 1, 2011 (CN) 201110048392.5

(51) Int. Cl. G06F 21/00

(52) U.S. Cl. 726/23

(57) ABSTRACT

A customer premises equipment (CPE) receives data packets from a network service device via a primary service flow. When the CPE detects flood of packets in the data packets received via the primary service flow, the CPE determines a source Internet protocol (IP) address of the flood of packets. The CPE establishes a new service flow with the network service device. A source IP address of the new service flow is set to the source IP address of the flood of packets, and a transfer speed of the new service flow is less than that of the primary service flow. The CPE transfers the flood of packets from the primary service flow to the new service flow.

### BACKGROUND

1. Technical Field

The present disclosure relates to network communications, and more particularly to a customer premises equipment (CPE) and a method for avoiding attacks.

2. Description of Related Art

A distributed denial-of-service (DDoS) attack can indicate that a multitude of compromised systems are attacking a single target system (such as a customer premises equipment) with flood of packets (i.e., packet flooding), thereby causing denial of service for users of the single target system. The flood of packets to the single target system essentially forces it to shut down, thereby denying service to legitimate users.

Therefore, it is a big challenge to avoid the DDoS attack.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of one embodiment of a customer premise equipment (CPE) in accordance with the present disclosure;

FIG. 2 is a transport diagram of a method for avoiding attacks in accordance with the present disclosure;

FIG. 3 is a schematic diagram of functional modules of one embodiment of the CPE in accordance with the present disclosure; and

FIG. 4 is a flowchart of one embodiment of the method for avoiding attacks in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

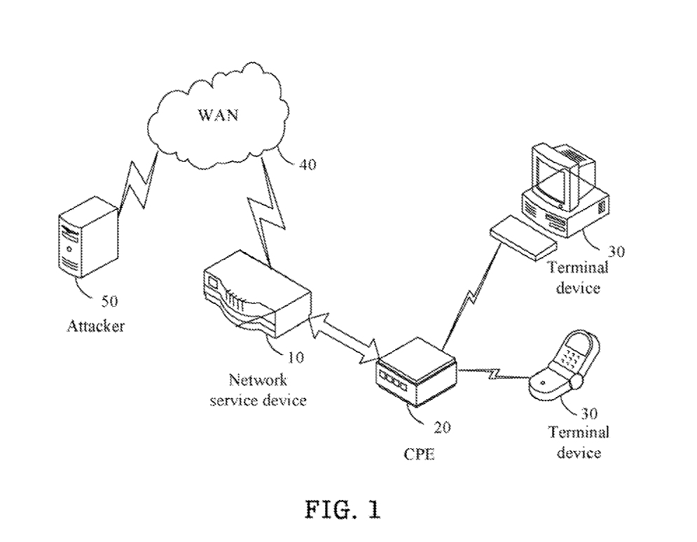

FIG. 1 is a schematic diagram of an application environment of one embodiment of a customer premises equipment (CPE) 20 in accordance with the present disclosure. In one embodiment, the CPE 20 is connected to a wide area network (WAN) 40 via a network service device 10, and the CPE 20 is also connected to a plurality of terminal devices 30. The CPE 20 provides network access service for the plurality of terminal devices 30.

In one example, the network service device 10 and the CPE 20 may respectively be a cable modem termination system (CMTS) and a cable modem, and the terminal devices 30 may be desktop computers, notebook computers, tablet computers, for example.

In another example, the network service device 10 and the CPE 20 may respectively be a world interoperability for microwave access (WIMAX) base station and a WIMAX subscriber station, and the terminal devices 30 may be mobile phones, notebook computers, for example. The WIMAX base station is also called a WIMAX access point, and the WIMAX subscriber station is also called a WIMAX CPE.

In one embodiment, the CPE 20 receives data packets from the network service device 10 via a primary service flow, but a distributed deny of service (DDoS) attacker 50 (called an attacker 50 for short hereinafter) may attack the CPE 20 over the WAN 40 and the network service device 10. That is, the attacker 50 floods the CPE 20 over the WAN 40 and the network service device 10 with many data packet requests (e.g., thousands, millions of packets), causing the primary service flow of the CPE 20 to be hindered. Thus, the CPE 20 cannot receive desirable data packets from the network service device 10 via the primary service flow, thereby causing denial of service for the terminal devices 30.

In one embodiment, when the CPE 20 detects that the data packets are being packet flooded in the data packets received via the primary service flow, the CPE 20 establishes a new service flow with the network service device 10, and transfers the flood of packets from the primary service flow to the new service flow, thereby avoiding the DDoS attack from the attacker 50.

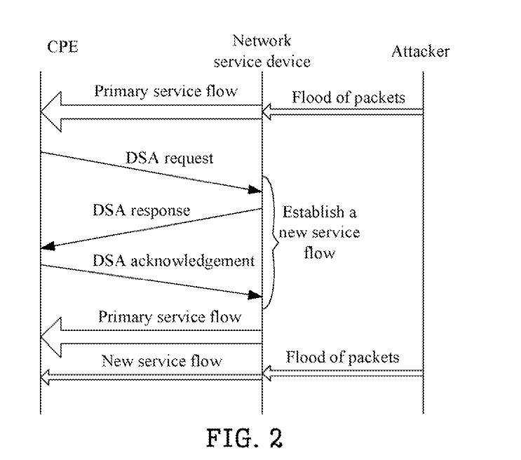

In detail, referring to FIG. 2, the CPE 20 determines whether that the data packets are being packet flooded via the primary service flow, and determines a source Internet protocol (IP) address of the flood of packets when the flood of packets are detected. In one embodiment, the CPE 20 gathers all source IP addresses of the data packets received via the primary service flow, and determines whether a number of the data packets with each source IP address within a predefined time is greater than a predefined number. The CPE 20 further determines that the flood of packets are detected when the number of the data packets with one source IP address within the predefined time is greater than the predefined number.

For example, the predefined number can be 10,000, the predefined time can be one second, and the data packets received via the primary service flow include a first source IP address and a second source IP address. If the CPE 20 receives 8000 data packets with the first source IP address within one second, the CPE 20 determines that the data packets with the first source IP address are not part of the flood of packets because 8,000 is less than 10,000. If the CPE 20 receives 12,000 data packets with the second source IP address within one second, the CPE 20 determines that the data packets with the second source IP address are flood of packets because 12000 is greater than 10,000. Accordingly, the CPE 20 determines that the source IP address of the flood of packets is the second source IP address.

Then, the CPE 20 establishes a new service flow with the network service device 10. A source IP address of the new service flow is set to the source IP address of the flood of packets, namely an IP address of the attacker 50. In one embodiment, the CPE 20 transmits a dynamic service addition (DSA) request to the network service device 10, receives a DSA response from the network service device 10, and transmits a DSA acknowledgement to the network service device 10, so as to establish the new service flow.

Finally, the CPE 20 transfers the flood of packets from the primary service flow to the new service flow, thereby avoiding the DDoS attack from the attacker 50.

In one exemplary embodiment, the CPE 20 can set a transfer speed of the new service flow so that the transfer speed of the new service flow is at least one hundred times less than that of the primary service flow. For example, the transfer speed of the primary service flow may be 1 MB/s, and the transfer speed of the new service flow may be 1 byte/s. Thus, the new service flow occupies less bandwidth of a communication channel.

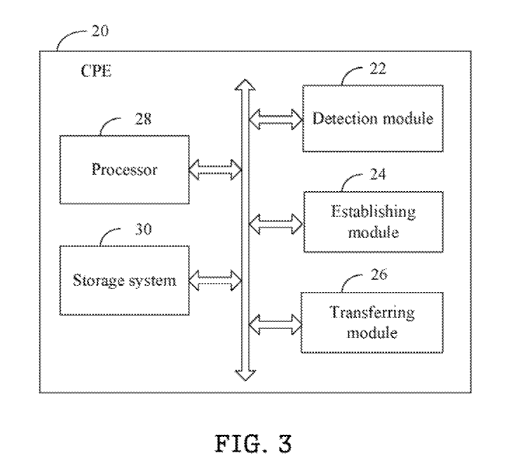

FIG. 3 is a schematic diagram of functional modules of one embodiment of the CPE 20 in accordance with the present disclosure. In one embodiment, the CPE 20 includes a detection module 22, an establishing module 24, a transferring module 26, at least one processor 28, and a storage system 30. The modules 22-26 may comprise computerized code in the form of one or more programs that are stored in the storage system 30. The computerized code includes instructions that are executed by the at least one processor 28 to provide functions for the modules 22-26.

The detection module 22 is operable to determine whether a flood of packets are detected in the data packets received via the primary service flow, and determine a source Internet protocol (IP) address of the flood of packets when the flood of packets are detected.

The establishing module 24 is operable to establish a new service flow with the network service device 10. A source IP address of the new service flow is set to the source IP address of the flood of packets, namely an IP address of the attacker 50. In one embodiment, the establishing module 24 transmits a DSA request to the network service device 10, receives a DSA response from the network service device 10, and transmits a DSA acknowledgement to the network service device 10, so as to establish the new service flow.

The transferring module 26 is operable to transfer the flood of packets from the primary service flow to the new service flow, thereby avoiding the DDoS attack from the attacker 50.

In one embodiment, the establishing module 24 is further operable to set a transfer speed of the new service flow so that the transfer speed of the new service flow is at least one hundred times less than that of the primary service flow. Thus, the new service flow occupies less bandwidth of a communication channel.

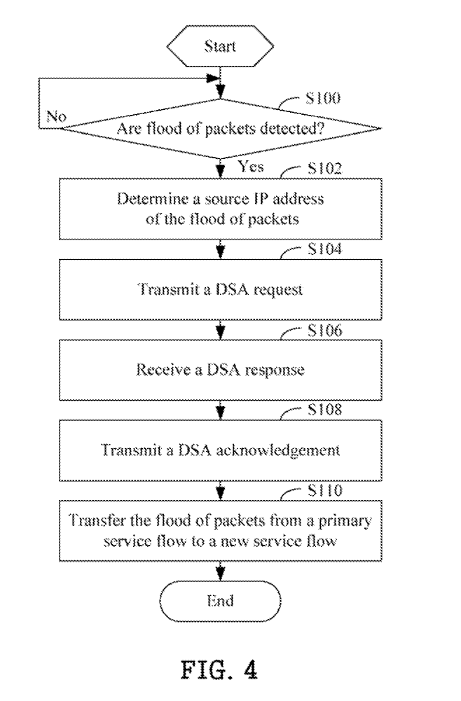

FIG. 4 is a flowchart of one embodiment of a method for avoiding attacks in accordance with the present disclosure. The method may be embodied in the CPE 20, and is executed by the functional modules such as those of FIG. 3. Depending on the embodiment, additional blocks may be added, others deleted, and the ordering of the blocks may be changed while remaining well within the scope of the disclosure.

In block S100, the detection module 22 determines whether a flood of packets are detected in the data packets received via the primary service flow.

If the flood of packets are detected in the data packets received via the primary service flow, in block S102, the detection module 22 determines a source IP address of the flood of packets.

In block S104, the establishing module 24 transmits a DSA request to the network service device 10.

In block S106, the establishing module 24 receives a DSA response from the network service device 10.

In block S108, the establishing module 26 transmits a DSA acknowledgement to the network service device 10. The DSA request, the DSA response, and the DSA acknowledgement are used to establish a new service flow between the CPE 20 and the network service device 10.

In general, blocks S104-S108 are used to establish the new service flow between the CPE 20 and the network service device 10.

In block S110, the transferring module 26 transfers the flood of packets from the primary service flow to the new service flow, thereby avoiding the DDoS attack from the attacker 50.

It should be noted that the method for avoiding attacks of the present disclosure can not only be applied in the CPE 20 such as a cable modem and a WIMAX CPE, but also be applied in the network service device 10 such as a CMTS and a WIMAX base station.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A customer premises equipment (CPE) connected to a network service device to receive data packets from the network service device via a primary service flow, the CPE comprising:
at least one processor;
a storage system;
one or more programs that are stored in the storage system and are executed by the at least one processor, the one or more programs comprising:
a detection module operable to determine whether a flood of packets are detected in the data packets received via the primary service flow, and determine a source Internet protocol (IP) address of the flood of packets if the flood of packets are detected;
an establishing module operable to establish a new service flow with the network service device, wherein a source IP address of the new service flow is set to the source IP address of the flood of packets, and a transfer speed of the new service flow is less than that of the primary service flow; and
a transferring module operable to transfer the flood of packets from the primary service flow to the new service flow.

2. The CPE of claim 1, wherein the flood of packets are distributed deny of service packets.

3. The CPE of claim 2, wherein the detection module gathers all source IP addresses of the data packets received via the primary service flow, determines whether a number of the data packets with each source IP address within a predefined time is greater than a predefined number, and determines that the flood of packets are detected when the number of the data packets with one source IP address within the predefined time is greater than the predefined number.

4. The CPE of claim 1, wherein the establishing module transmits a dynamic service addition (DSA) request to the network service device, receives a DSA response from the network service device, and transmits a DSA acknowledgement to the network service device, so as to establish the new service flow.

5. The CPE of claim 1, wherein the transfer speed of the new service flow is at least one hundred times less than that of the primary service flow.

6. A method for avoiding attacks of a customer premises equipment (CPE), the CPE being connected to a network service device to receive data packets from the network service device via a primary service flow, the method comprising:
determining whether a flood of packets are detected in the data packets received via the primary service flow;
determining a source Internet protocol (IP) address of the flood of packets if the flood of packets are detected;
establishing a new service flow with the network service device, wherein a source IP address of the new service flow is set to the source IP address of the flood of packets, and a transfer speed of the new service flow is less than that of the primary service flow; and
transferring the flood of packets from the primary service flow to the new service flow.

7. The method of claim 6, wherein the flood of packets are distributed deny of service flood of packets.

8. The method of claim 7, wherein the step of determining whether flood of packets are detected in the data packets received via the primary service flow comprises:
gathering all source IP addresses of the data packets received via the primary service flow;
determining whether a number of the data packets with each source IP address within a predefined time is greater than a predefined number; and
determining that the flood of packets are detected when the number of the data packets with one source IP address within the predefined time is greater than the predefined number.

9. The method of claim 6, wherein the establishing step comprises:
transmitting a dynamic service addition (DSA) request to the network service device;
receiving a DSA response from the network service device; and
transmitting a DSA acknowledgement to the network service device;
wherein the DSA request, the DSA response, and the DSA acknowledgement is used to establish the new service flow.

10. The method of claim 6, wherein the transfer speed of the new service flow is at least one hundred times less than that of the primary service flow.
